(19) United States
(12) Patent Application Publication
(10) Pub. No.: US 2021/0366072 A1
(43) Pub. Date: Nov. 25, 2021

(54) SYSTEM AND METHOD FOR SITUATIONAL AWARENESS ASSIST VIEW

(71) Applicant: PatriotOne Technologies, Toronto (CA)

(72) Inventors: Jonathan Taylor MILLAR, Fredericton (CA); James Allan Douglas CAMERON, Fredericton (CA); Matthew Aaron Rogers CARLE, Fredericton (CA)

(21) Appl. No.: 17/330,323

(22) Filed: May 25, 2021

Related U.S. Application Data
(60) Provisional application No. 63/029,606, filed on May 25, 2020.

(51) Int. Cl. G06Q 50/26; G06F 9/451; G06N 20/00; G06N 5/04; G06K 9/00; H04N 7/18; G08B 3/00; G08B 5/00; G08B 6/00

(52) U.S. Cl. CPC G06Q 50/265; G06F 9/451; G06N 20/00; G06N 5/04; G08B 6/00; H04N 7/181; G08B 3/00; G08B 5/00; G06K 9/00771

(57) ABSTRACT

Embodiments described herein relate to a threat detection system that shows a user an incident as it develops in real time by leveraging artificial intelligence (AI) to more accurately focus cameras and highlight the areas of concern within those feeds, providing a much more efficient user interface to the operator. These annotated feeds and feed focused triggering events can also be connected to third party systems. This timeline of events and evidence (small annotated clip of detection when available) is archived and can be reviewed at a later date, containing an accurate timeline of the incident as it progressed.

### CROSS REFERENCE TO RELATED APPLICATIONS

The application claims priority to and the benefit of U.S. Provisional Patent Application Ser. No. 63/029606, entitled “SYSTEM AND METHOD FOR SITUATIONAL AWARENESS ASSIST VIEW”, filed on May 25, 2020, the disclosure of which are incorporated herein by reference in their entirety.

### BACKGROUND

The embodiments described herein relate to security and surveillance, in particular, technologies related to video recognition threat detection.

A software platform for threat detection solutions is described. This software platform may use radar or other technologies to detect concealed weapons such as guns and knives. Existing systems simply use motion or other triggers to focus cameras in front of a user, and in some cases place a highlight box around the subject of interest.

Currently many sensors, such as cameras have to be manually monitored by humans (i.e., security personnel) and with the growing number of cameras in facilities it is difficult to track them all. This may lead to info being missed.

There is a desire to incorporate advanced sensing technology and artificial intelligence in a threat detection system to better track and detect potential threats.

### SUMMARY

Embodiments described herein relate to a threat detection system that shows a user an incident as it develops in real time by leveraging artificial intelligence (AI) to more accurately focus the attention of the user on specific cameras or other sensors and highlight the areas of concern within those feeds, providing a much more efficient user interface to the operator. These annotated feeds and feed-focused triggering events can also be connected to third party systems. This timeline of events and evidence (a small annotated video clip surrounding a detection event when available) is archived and can be reviewed at a later date, containing an accurate timeline of the incident as it progressed.

### BRIEF DESCRIPTION OF THE DRAWINGS

FIG. 1 is a diagram illustrating a timeline of events.

FIG. 2 is a diagram illustrating Area 1 from FIG. 1 populated with a threat detection event.

FIG. 3 is a further diagram illustrating a timeline of event as the incident develops.

FIG. 4 is a diagram illustrating a high confidence detection of a threat that has triggered an alert in the system.

FIG. 5 is screenshot illustrating a dashboard of an exemplary threat detection system.

FIG. 6 is a screenshot illustrating a further dashboard screen showing the state when a sensor is down and a sensor has detected an alert.

FIG. 7 is a screenshot illustrating an alert detection screen.

FIG. 8 is a dashboard screenshot showing new functionality that forces the operator to enter a reason when clearing an alert.

FIG. 9 is a further dashboard screenshot enabling the addition of notes.

FIG. 10 is a screenshot illustrating Assist view of an exemplary threat detection system.

FIG. 11 is a screenshot showing a view of one exemplary sensor.

FIG. 12 is a screenshot illustrating an exemplary threat detection event.

FIG. 13 is a screenshot illustrating the escalation of a threat with a possible detection by separate sensors.

FIG. 14 is a screenshot illustrating a Sensor Management view of the threat detection system.

FIG. 15 is a system diagram of an exemplary threat detection system.

### DETAILED DESCRIPTION

In a preferred embodiment, a multi-sensor covert threat detection system is disclosed. This covert threat detection system utilizes software, artificial intelligence and integrated layers of diverse sensor technologies (e.g. cameras, etc.) to deter, detect and defend against active threats (e.g., detection of guns, knives or fights) before these threat events occur.

The threat detection system enables the system operator (user) to easily determine if the system is operational without requiring testing with actual triggering events. This system also provides more situational information to the operator in real time as the incident is developing, and shows them what they need to know, when they need to know it.

Within this system, a threat could move through a multi sensor gateway that would not only focus the camera on that gate, but show the operator all of the detections in one place as they happen. The solution amalgamates all sensors and their detections into a single dashboard of focus for the user, whilst providing the ability for forensic review after the event, clearly showing when and where detections took place, with the recorded evidence.

The system features the ability to display to a user all relevant situational sensor information during a threat event, as it develops through a facility in real time. The system uses artificial intelligence (AI) to not only inform a user which cameras should be in focus, but may highlight where in the camera frame they should focus their attention. This more efficient approach will clearly show the user the system's increasing confidence in event detections, so information is less likely to be missed by the user, thus allowing the user to react in a real-time manor to an active threat. All of this UI dashboard and integrated Al event tracking combines to create a valuable timeline of an event that can be used for future forensic analysis and reporting.

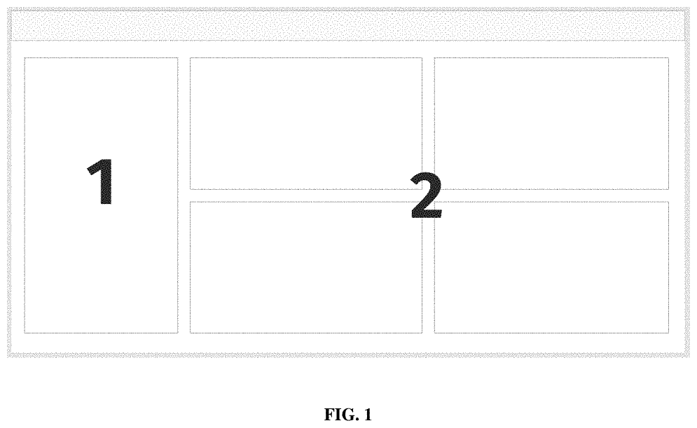

FIGS. 1-15 illustrate one implementation of this system. Other arrangements of screens and displays of this functionality may be easily devised from this basis by those skilled in the art.

FIG. 1 is a diagram illustrating a timeline of events. In FIG. 1, there are 2 main areas: Area 1 and Area 2. Area 1 represents the timeline of events with the newest at the top. Clicking (selecting) one of these events will show the recorded evidence if available. Area 2, represents the area live feeds annotated by Al.

In one implementation, the sensor feeds will occupy as much space as is available. For example, 1 sensor feed will occupy the entire space if no other sensor feeds have been brought into focus. Sensor feeds cycle through Area 2 in a first in first out fashion based on last detection for that sensor.

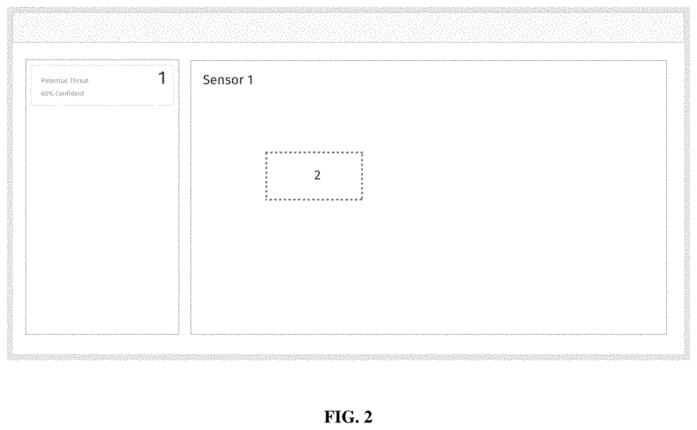

FIG. 2 is a diagram illustrating Area 1 from FIG. 1 populated with a threat detection event. The corresponding sensor (Sensor 1, Box 2) has been focused on the right filling the full frame. Area 2 represents the possible threat detection and is indicated to the user so they know what to focus on in the frame.

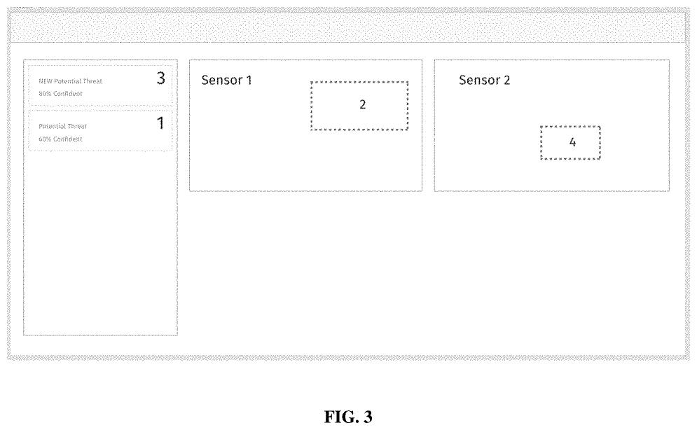

FIG. 3 is a further diagram illustrating a timeline of events as the incident develops. The existing event (Event 1) has moved down in the timeline, and its sensor and new possible threat detection (Event 3) occupy the upper right quadrant of the sensor area, making room for new sensor alert (Sensor 2). The second detection event (Event 3) is now the first in the list and its sensor (Sensor 2) and possible detection (Box 4) now occupy the upper right quadrant of the sensor area. As the incident develops, the system shows the user all of the information the system has, the confidence the system has in the detection, and shows the user where their focus should be.

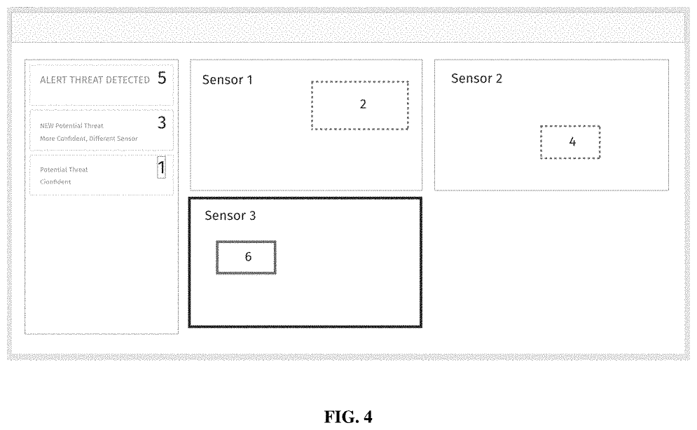

FIG. 4 is a diagram illustrating a high confidence detection of a threat that has triggered an alert in the system. A new possible threat is added to the top of the timeline on the left (Event 5). It's corresponding sensor is loaded and occupies the lower left quadrant of the sensor area (Sensor 3, Box 6). This sensor feed has a thick border around it indicating it has a high confidence corresponding alert. The system also shows the user where their focus should be in the frame (Box 6).

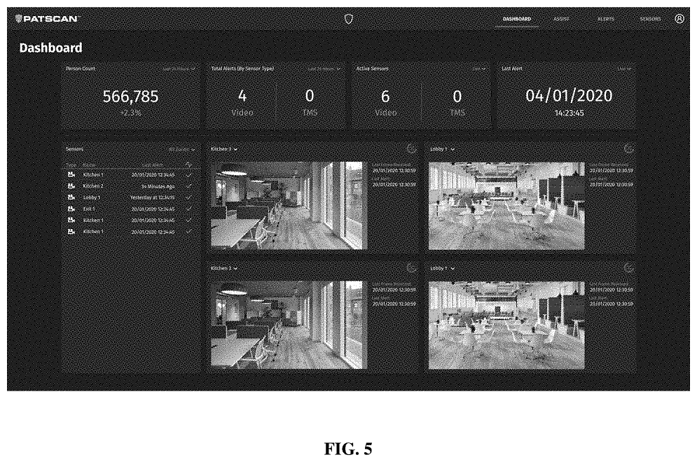

FIG. 5 is screenshot illustrating a dashboard of an exemplary threat detection system. As seen in FIG. 5, the dashboard provides the operator with easily understandable information on the overall health of the system. Along the top is at-a-glance information widgets, which will provide the user with some at a glance statistics relating to the health and overall operation of the system.

The person count stat shows that the system is working as the number generally increases as people walk through frames. This count is not to provide specific threat information, instead, it is to show things are working. This number can be used as a secondary check for other systems, such as turnstile entry systems, crowding or social distancing indicators. On the left is a list of the sensors and their status. On the right is a quadrant of 4 sensors. In the neutral (non-threat detected) system state here, they will rotate through sensor feeds randomly or in sequence showing the last frame captured and the last time that sensor triggered an alert.

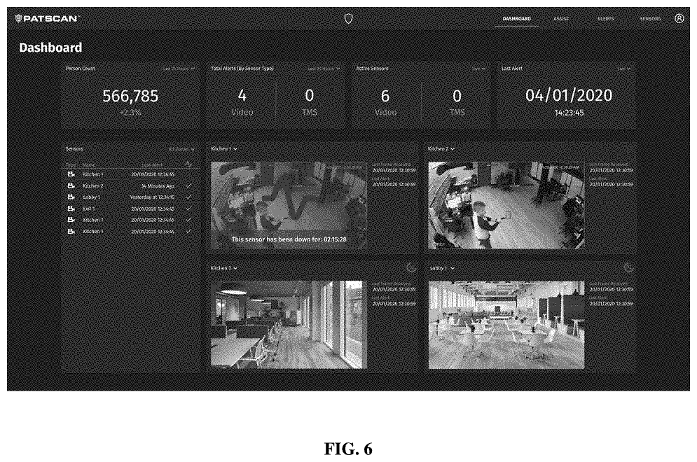

FIG. 6 is a screenshot illustrating a further dashboard screen showing the state when a sensor is down (inoperative, or indicating an error code) and a different sensor has detected an alert. On the left of the dashboard screen, the operator will be shown a list of sensors with the malfunctioning one at the top. On the right of the dashboard screen, the operator is shown the 2 highest priority feeds at the top, with one indicating how long it has been down for, and another that will show the detected alert frame.

The right side of the dashboard shows a list of the sensors and their status. The system will determine the status of a sensor based on the last time it has heard from it. This heartbeat signal allows the system to show when a sensor goes down. Clicking on a sensor will navigate the operator to the alerts view.

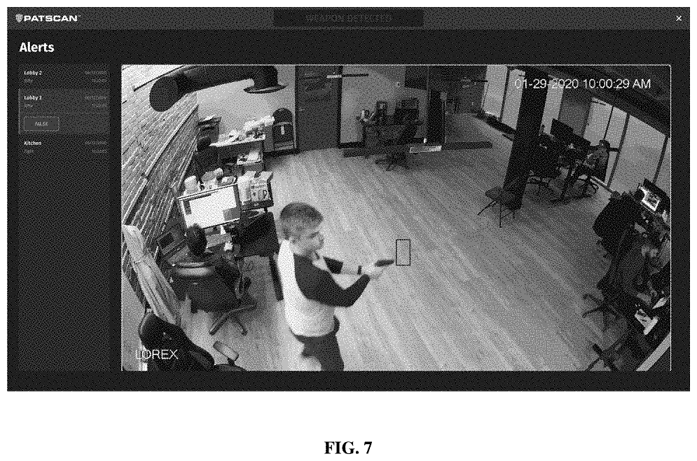

FIG. 7 is a screenshot illustrating an alert detection screen. As seen in FIG. 7, the dashboard shows an alert illustrating a threat to the system operator. When an alert is detected by the system, the operator will be shown a header that makes it very clear that should be their only focus. As seen in FIG. 7, a gun is detected. A box is placed in proximity of the gun and is shown on the dashboard screen. Further, an alert of “WEAPON DETECTED” is shown and highlighted in red. Further, an audio alert and mobile notification is also triggered.

Simplicity is one of the goals of this screen as well as trying to enforce good work flow. Ideally, there should not be many alerts here so the operator is forced to select each alert before giving them the ability to clear it. This forces the operator to evaluate the threat before dismissing it.

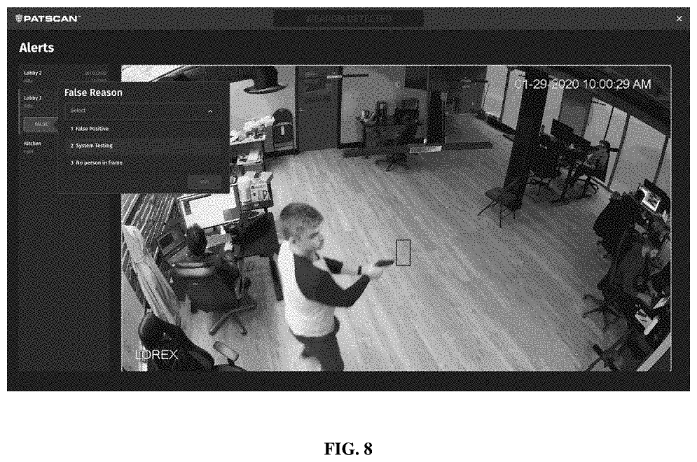

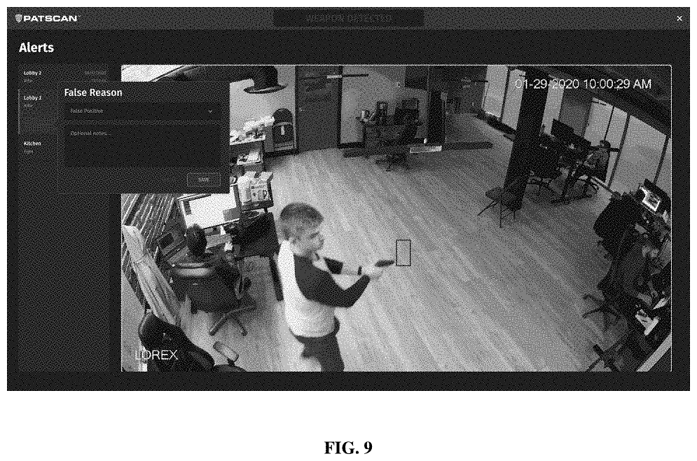

FIG. 8 is a dashboard screenshot showing new functionality that forces the operator to enter a reason when clearing an alert. This will enable the system to collect stats and feedback from the users, as well as, give better data for reporting and forensics. The operator is forced to select from a list of predefined reasons (configured ahead of time by admin) and numbers allow for fast keyboard input. FIG. 9 is a further dashboard screenshot enabling the addition of notes. Although the user is only allowed to select from pre-determined reasons, they are able to add additional notes. For efficiency of use, the reason codes may be pre-programmed into a custom key array.

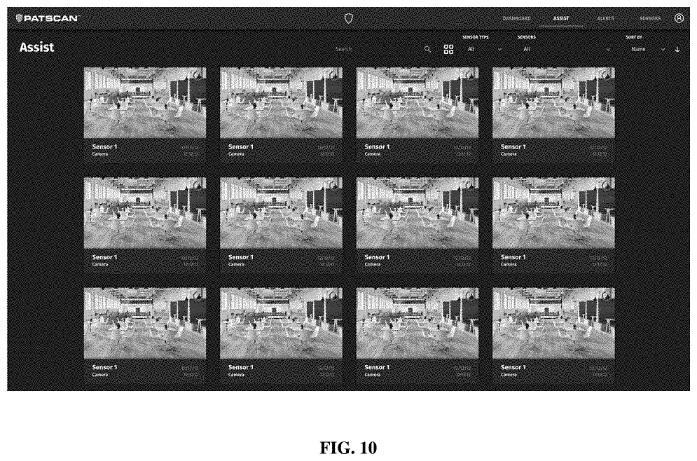

FIG. 10 is a screenshot illustrating Assist view of an exemplary threat detection system. As seen in FIG. 10, the operator is shown an array of sensors (i.e., cameras) that show the last frame and refresh every second. Clicking on one of these will show a live annotated feed (8 fps) and any recent events for that sensor.

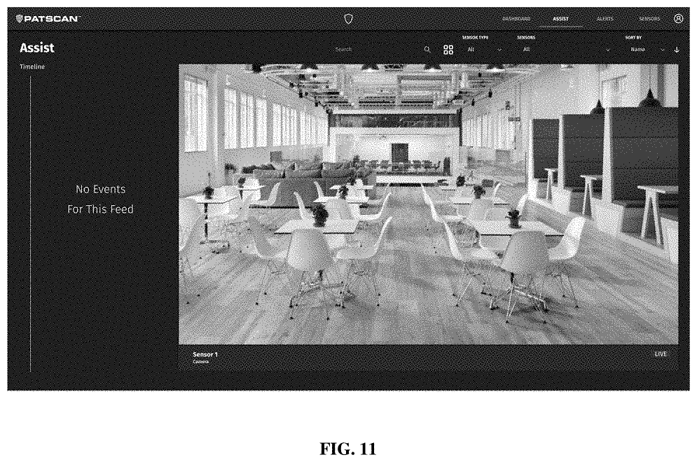

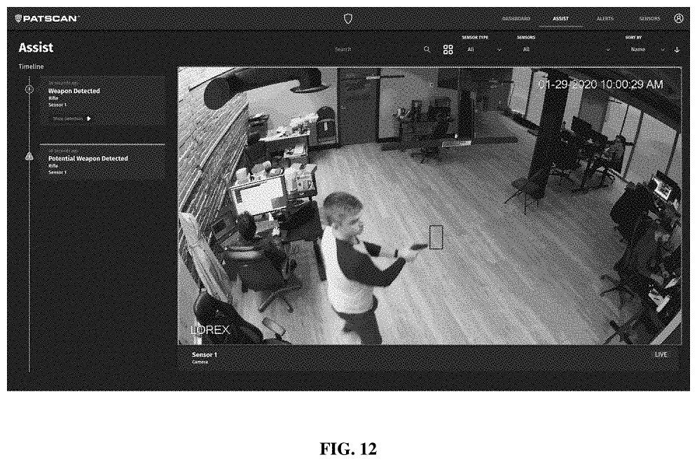

FIG. 11 is a screenshot showing a view of one exemplary sensor. As seen in FIG. 11, a timeline is shown on the left with a sequence of events. A live feed of the sensor (i.e., camera) is shown on the right. FIG. 12 is a screenshot illustrating an exemplary threat detection event. As seen in FIG. 12, one or more events are detected for a sensor. The system focuses that sensor and provide the operator with a live 8 fps annotated feed. Here the system not only shows the operator what to focus on, but where in the video feed the threat may be.

As seen in FIG. 12, on the left is a timeline of events with the ability to see additional information they contain (gifs). Clicking on an alert here could take the user to the alerts management screen. The goal here is not to have the operator sit and process alerts, but to show them as much information as the system has concerning the ongoing threat.

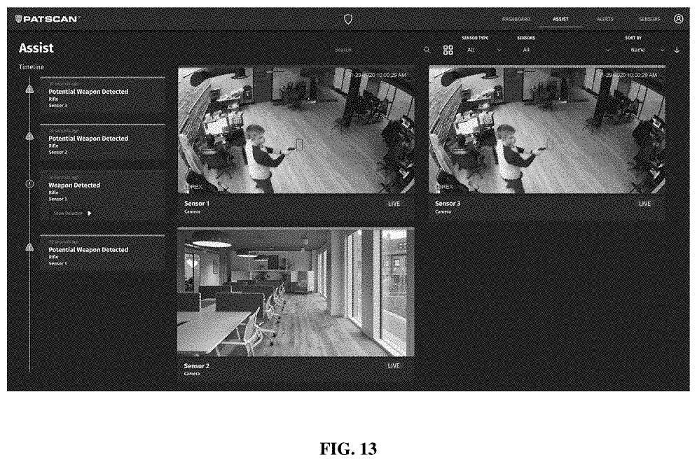

FIG. 13 is a screenshot illustrating the escalation of a threat with a possible detection by separate sensors. When this happens the feeds are split and the operator is shown both feeds long with the new event in the timeline. Further, the new feed is annotated with boxes indicating the threatening object (i.e., a gun). As the situation escalates the view will continue to split to a maximum of 4 sensor feeds. As seen in FIG. 13, 3 sensor feeds are shown with boxes highlighting the objects of interest for the treat.

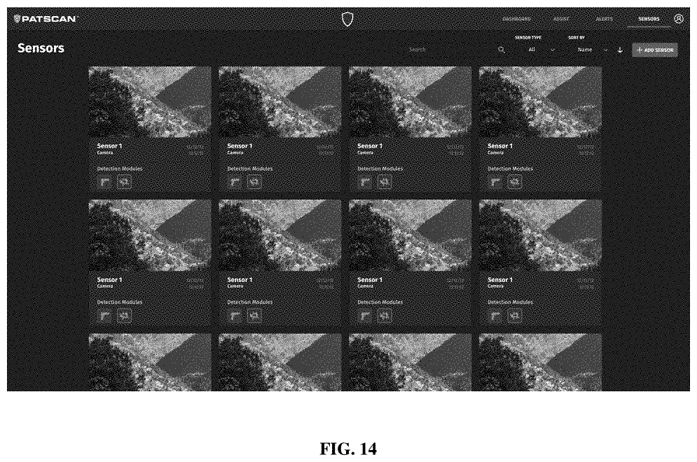

FIG. 14 is a screenshot illustrating a Sensor Management view of the threat detection system. This view allows for admin access and easy management of sensors across the system. The Information Technology (IT) department's goal is to provide at a glance information about sensor status as well as in the future integrate license management and detection module management within the license and system capabilities. This view, allows users to control what detection modules are running on which sensors.

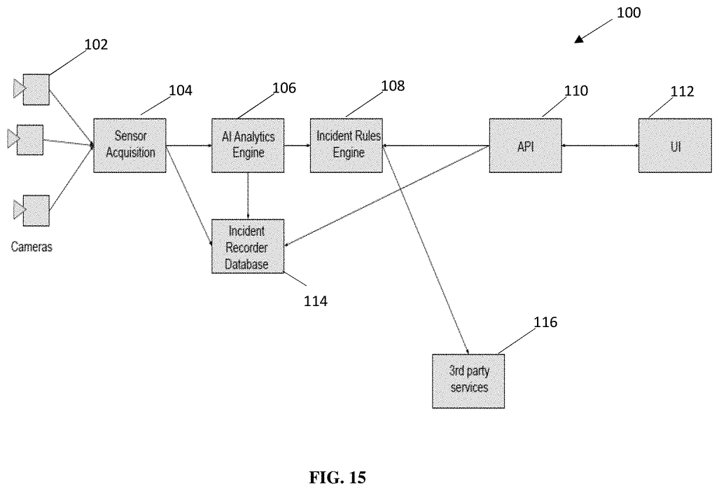

FIG. 15 is a system diagram of an exemplary threat detection system. As seen in FIG. 15, threat detection system 100 consist of one or more cameras 102 configured to record video data (images and audio). Cameras 102 is connected to sensor or sensor acquisition module 104. Once the data is acquired, the data is sent simultaneously to an AI Analytics Engine 106 and Incident Recorder Database 114. Al Analytics Engine 106 analyzes the data with input from an Incident Rules Engine 108. Thereafter, the data is sent to an application program interface (API) 110 or sent to 3rd party services 116. The output form the API 110 will be sent to a user interface (UI) 112 or graphical user interface (GUI). Furthermore, the output from the API 110 and Al Analytics Engine 106 will be further recorded at the Incident Recorder Database 114.

In a further embodiment, disclosed herein is a multi-sensor threat detection system used for displaying real-time threat detection, the system comprising a processor to compute and process the data, a plurality of video camera configured to capture image data, a sensor acquisition module, an artificial intelligence (AI) algorithm to provide instructions to focus the camera of on areas of concern and to identify an item as a possible threat, and a graphical user interface (GUI) to provide an update of real-time data feeds based on the processed feeds. The real-time data feed is an annotated feed consisting of a timeline of events and evidence, as well as a small annotated clip of the detection event.

The multi-sensor threat detection system is shown wherein a possible threat includes a gun, knife or a concealed weapon. The multi-sensor threat detection system further comprises a notification/alert module to provide alert to security personnel or operator. The multi-sensor threat detection where the events and evidence can be archived and be reviewed at a later date, providing an accurate timeline of the incident as the incident progresses.

The multi-sensor threat detection system wherein the graphical user interface (GUI) is further configured to display escalation of a threat with detection by separate sensors. The GUI further comprise a dashboard screen to consolidate all the real-time data feeds. The GUI displays a box around the potential threat item on the dashboard screen. The GUI alerts the user. Preferably, the alert comprises further displaying to the user an alert of “WEAPON DETECTED” in red, initiating an audible notification, or a combination of these.

In a further embodiment, a computer-implemented method for displaying real-time threat using a multi-sensor threat detection system is disclosed. The method comprises receiving image data from cameras (sensor) from the multi-sensor threat detection system, processing the data using an artificial intelligence algorithm, aggregating the data, displaying the data on a graphical user interface (GUI) as a newsfeed, updating the newsfeed with real-time updates, and providing an alert warning when a threat is identified.

According to the computer-implemented method, the threat includes identification of a weapon or a concealed weapon. The graphical user interface (GUI) of the computer-implemented method includes a dashboard screen to consolidate all the real-time data feeds. The GUI displays a box around the potential threat item on the dashboard screen. Furthermore, the GUI further alerts the user, preferably displaying, to the user, an alert of “WEAPON DETECTED” in red, initiating an audible notification, or a combination of these.

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. It should be noted that a computer-readable medium may be tangible and non-transitory. As used herein, the term “code” may refer to software, instructions, code or data that is/are executable by a computing device or processor. A “module” can be considered as a processor executing computer-readable code.

A processor as described herein can be a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, or microcontroller, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, any of the signal processing algorithms described herein may be implemented in analog circuitry. In some embodiments, a processor can be a graphics processing unit (GPU). The parallel processing capabilities of GPUs can reduce the amount of time for training and using neural networks (and other machine learning models) compared to central processing units (CPUs). In some embodiments, a processor can be an ASIC including dedicated machine learning circuitry custom-build for one or both of model training and model inference.

The disclosed or illustrated tasks can be distributed across multiple processors or computing devices of a computer system, including computing devices that are geographically distributed.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The system should therefore not be limited by the above described embodiment, method, and examples, but by all embodiments and methods within the scope and spirit of the system. Thus, the present disclosure is not intended to be limited to the implementations shown herein but is to be accorded the widest scope consistent with the principles and novel features disclosed herein.

What is claimed is:

1. A multi-sensor threat detection system used for displaying real-time threat detection, the system comprising:
a processor to compute and process the data;
a plurality of video cameras configured to capture image data;
a sensor acquisition module;
an artificial intelligence (AI) algorithm to provide instructions to identify an area of concern and to identify an item as a possible threat; and
a graphical user interface (GUI) to provide an update of real-time data feeds based on the processed feeds.

2. The system of claim 1 wherein a possible threat includes a gun, knife or a concealed weapon.

3. The system of claim 1 further comprising a notification/alert module to provide an alert to security personnel or operator.

4. The system of claim 1 wherein the real-time data feed is an annotated feed.

5. The system of claim 1 where the real-time data feed includes a visual representation of an area of concern.

6. The system of claim 5 where the visual representation of an area of concern is enhanced with an indication of a threat.

7. The system of claim 4 wherein the real-time data feed is a timeline of events and evidence.

8. The system of claim 7 where the evidence further comprises a small annotated clip of detection.

9. The system of claim 4 where the events and evidence can be archived and be reviewed at a later date, providing an accurate timeline of the incident.

10. The system of claim 1 wherein the graphical user interface (GUI) is further configured to display escalation of a threat with detection by separate sensors.

11. The system of claim 10 wherein the graphical user interface (GUI) further comprises a dashboard screen to consolidate all the real-time data feeds.

12. The system of claim 1 wherein the graphical user interface (GUI) displays a box around the potential threat item on the dashboard screen.

13. The system of claim 1 wherein the graphical user interface (GUI) further displays to the user an alert.

14. The system of claim 13 wherein the alert initiates an audible notification.

15. A computer-implemented method for displaying real-time threats using a multi-sensor threat detection system, the method comprising:
receiving image data from cameras (sensor) from the multi-sensor threat detection system;
processing the data using an artificial intelligence algorithm;
aggregating the data;
displaying the data on a graphical user interface (GUI) as a newsfeed;
updating the newsfeed with real-time updates; and
providing an alert warning when a threat is identified.

16. The method of claim 15 wherein the threat detection includes identification of a weapon or a concealed weapon.

17. The method of claim 15 wherein the graphical user interface (GUI) includes a dashboard screen to consolidate all the real-time data feeds.

18. The method of claim 17 wherein the graphical user interface (GUI) displays any one of a box, a circle, an arrow, a localized color change, a weapon icon or direction indicator around or near the potential threat item on the dashboard screen.

19. The method of claim 15 wherein the graphical user interface (GUI) further displays, to the user, an alert.

20. The method of claim 17 wherein the alert initiates an audible, tactile or remote notification.
